(19) United States
(12) Patent Application Publication
(10) Pub. No.: US 2003/0067540 A1
(43) Pub. Date: Apr. 10, 2003

(54) Bond test site image capture inspection system

(76) Inventor: Malcolm Cox, Napa, CA (US)

Correspondence Address: Malcolm Cox, 3560 Hagen Rd., Napa, CA, 94558, US

(21) Appl. No.: 09/972,660

(22) Filed: Oct. 9, 2001

(51) Int. Cl. H04N 7/18

(52) U.S. Cl. 348/126; 382/141; 382/145; 382/146

(57) ABSTRACT

An apparatus to attach to a Multifunction Bond Strength Test Machine 1 to incorporate a digital camera 13 with zoom optics 14 and integrating software incorporated in a computer 16, including; A secure and reliable mounting system 15 that attaches the camera 13 and optics 14 to the Multifunction Test System 1, computer with embedded frame grabber circuitry 16 and software controls for the coordination of automatic positioning of test sites 9 under the camera 13 and identification of the specific test sites 9, software for capture and manipulation of the digital image of the test site 18, and software for quantification of image features.

### BACKGROUND

1. Field of Invention

This invention relates to apparatus attached to a multifunction tester of bonds used in the manufacture of microelectronics devices, for the expressed purpose of capturing a digital photographic image of a bond site immediately after destructive or non-destructive tests, suitable for subsequent analysis.

2. Description of Prior Art

Various structures of microelectronic devices employ bonding techniques as part of the assembly of the devices, most notably, but not limited to, wire lead connections that interconnect integrated circuit chips to external lead frames. As mechanical connections including bonds, are usually the Achilles heels of electronics circuits, a means to insure adequate quality of these bonds has been developed and is currently in use by device manufacturers as a process control measure. To insure acceptable integrity and reliability, microelectronics device manufacturers regularly check the strength of the bonds on a sampling basis by utilizing apparatus known as “Multifunction bond and material strength destructive and non destructive test machines” typified by Royce Instruments Inc. systems 552, 580 and others. These systems provide useful strength data to their users for development, evaluation, quality control and problem diagnosis.

The test systems with currently available features are very useful to provide raw strength data and with the addition of microprocessor based data manipulation capability can also provide data input and display for trend analysis and statistical process control. Utility for development and problem diagnosis is limited however, by the difficulty in observing and quantifying the characteristics of the bonds broken apart by the test. If the destructive test of bonds shows strengths below established control limits, it is desirable to be able to observe and analyze the failed bond structure to ascertain the nature of the weakness to expose process problems or limitations and/or to develop solutions or improvements. This is currently difficult to accomplish because:

a) The observation must be accomplished through an up to 80×power microscope, with the image typically viewable on a practical basis only by the test machine operator.

b) An image of the bond area is not captured, so observations must be collected manually in real time. This makes the observations subject to the interpretation of the test equipment operator who may not have analytical expertise.

c) Consistent conclusions are difficult to achieve. Without cooperative analysis, it is difficult to create harmonized standards for interpretation of failure modes, especially between tests conducted at separated manufacturing facilities.

### SUMMARY

The invention described herein is comprised of an apparatus that attaches to a Multi function bond strength test machine that incorporates a digital camera with a suitably magnifying lens synchronized with the machine control system to identify and capture an image of the remnants of a tested bond site for assessments of failure modes and to provide measurement of features within the test site.

### OBJECTS AND ADVANTAGES

Objects and advantages of the invention are:

a) To provide a means to permanently capture images of tested bonds for subsequent off line analysis.

b) To synchronize the image with specific tested bonds and identify them accordingly.

c) To provide a means of measurement of test site features.

d) To provide a means of quantifying useful characteristic such as residual cross section(s), inclusions, defect densities, etc.

e) To provide a means for analysis of failure modes and their root causes.

f) To enable establishment of standards suitable for accurate assessment of characteristics, observer-to-observer and location-to-location.

g) To provide for capture of the image of the bond test site normal to its plane for accurate measurement of cross-sectional areas.

### DRAWING FIGURES

FIG. 1 shows the general arrangement of a Multifunction Bond Test System incorporating the components of the Image Capture feature that is the object of this invention.

FIG. 2 shows the computer that is included in the Image Capture feature and illustrates the display of the captured image along with accompanying data.

FIG. 3 shows a test piece held in a test piece holder and the bonds to be tested and subsequently have their images captured after testing.

FIG. 4 shows a test piece with bonds held in position to be tested by a test tool that will shear the bond with the force required to shear the bond measured by means of a transducer module

FIG. 5 shows the movement required of the X-Y stage to position the bond to be tested under the test tool, move the subsequent test site after test to the center of the optics for Image Capture and return to under the test tool to be ready for the next test

FIGS. 6 and 7 show detail of a bond ready to be tested and a bond test site after a shear test

FIG. 8 is a photo of a display of a Captured Image

### REFERENCE NUMERALS IN DRAWINGS

1 Multifunction Bond test System

2 X-Y Stage

3 Shear Force measurement transducer module

4 Test tool

5 Test piece holder

6 Test piece holder jaws

7 Test piece

8 Bond (in typical array) before shear test

9 Bond test site after shear test

10 Test position under test tool

11 Center of tested bond under Image Capture Optics

12 Tested Bond

13 Electronic camera

14 Zoom Optics

15 Mounting for optics

16 Computer with frame grabber circuitry

17 Computer monitor

18 Image of tested Bond

19 Displayed test data

### DESCRIPTION

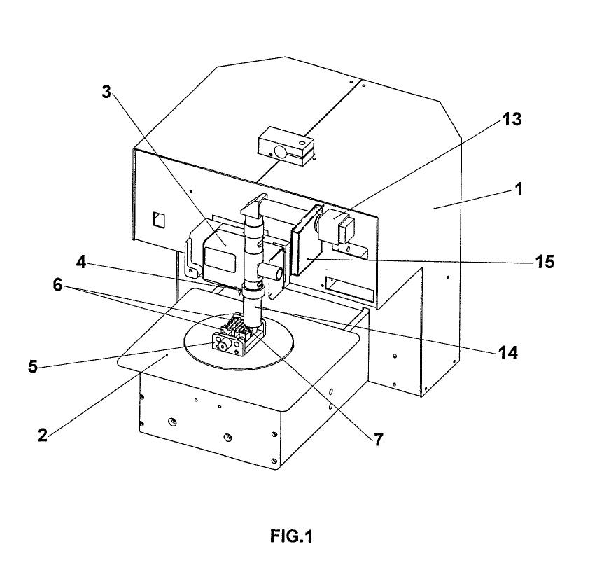

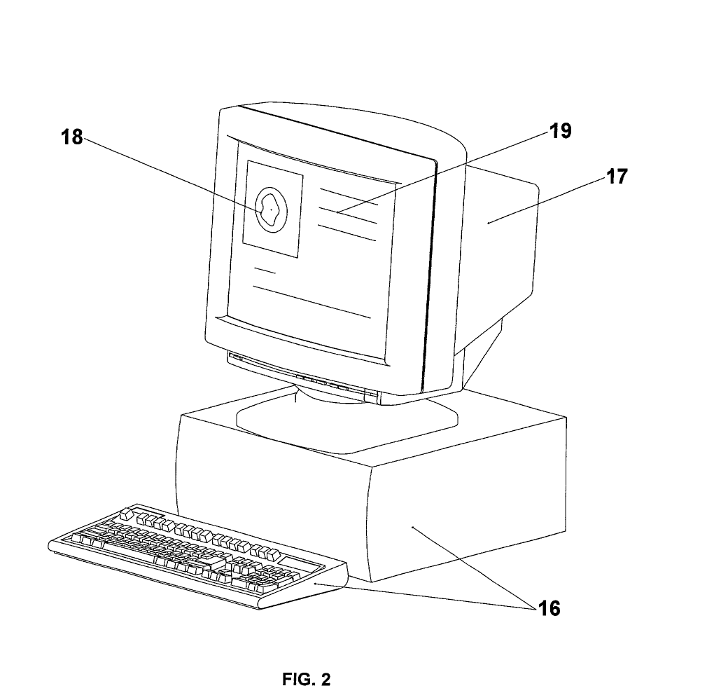

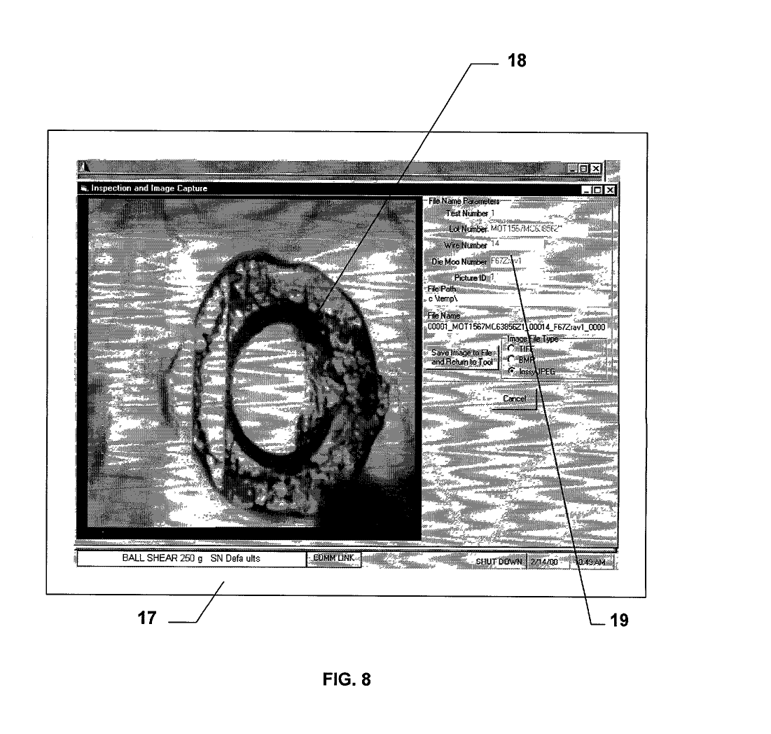

### FIGS. 1, 2, and 8—Preferred Embodiment

The preferred embodiment of the invention is illustrated in FIGS. 1, 2 and 8.

Image capture apparatus consists of:

a) Color Electronic camera 13 with typical electronic video interface to convert the image into digital format.

b) Zoom optics 14 to allow adjustment of magnification and field of view.

c) Mounting hardware 15 to position the optics and camera.

d) Computer with frame grabber circuitry and software 16 to process image information and display the image 18 on the monitor 17.

e) Software to manage the interaction of the Multifunction bond strength test machine, camera and computer.

f) Software to control captures of image to user definable file types and location and measure quantifiable image features.

Advantages:

a) Image capturing can be set up to be accomplished automatically at any desired test interval,

b) (E.g. every 3^{rd} test, every 10^{th} test etc.), semi-automatically triggered by operator entry of a specifically coded failure mode of a test or completely manual.

c) The image is taken normal to the plane of the test site so that cross section measurements can be accomplished accurately.

d) Measurements of cross-sections can be taken automatically.

e) The image is automatically tagged with identification data.

f) The image is automatically correlated to the corresponding test data.

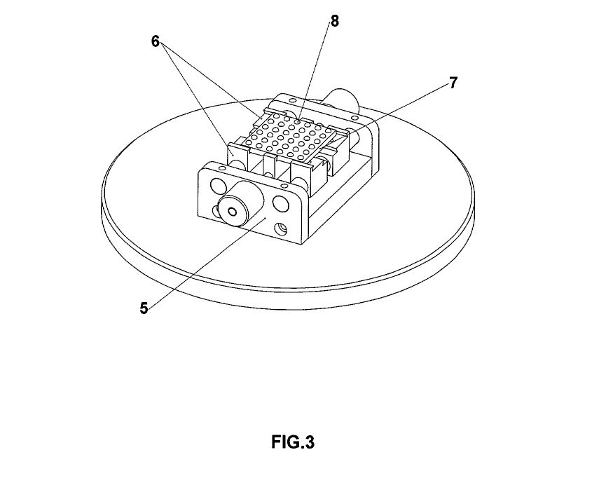

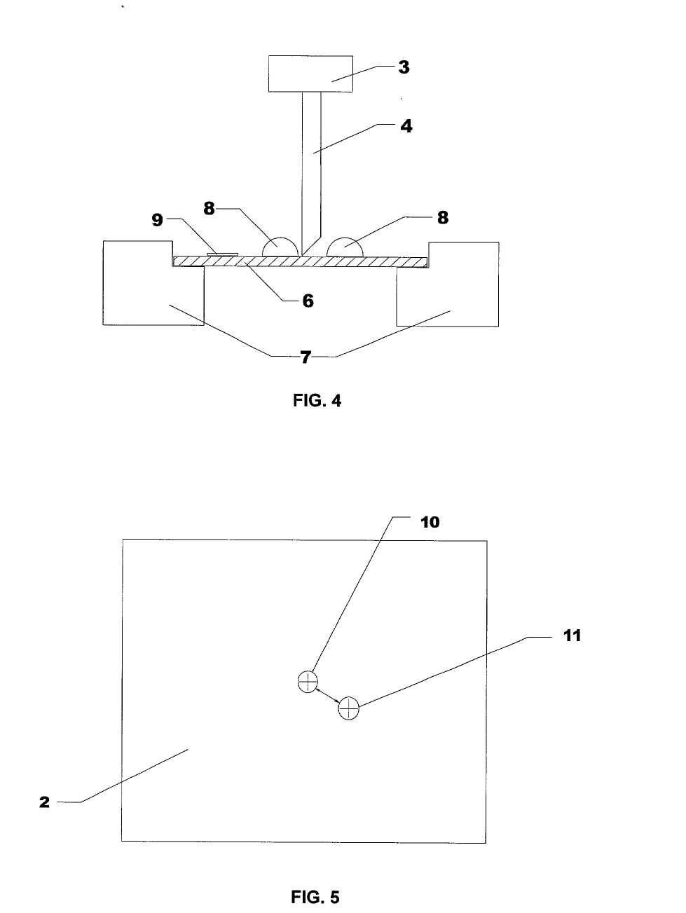

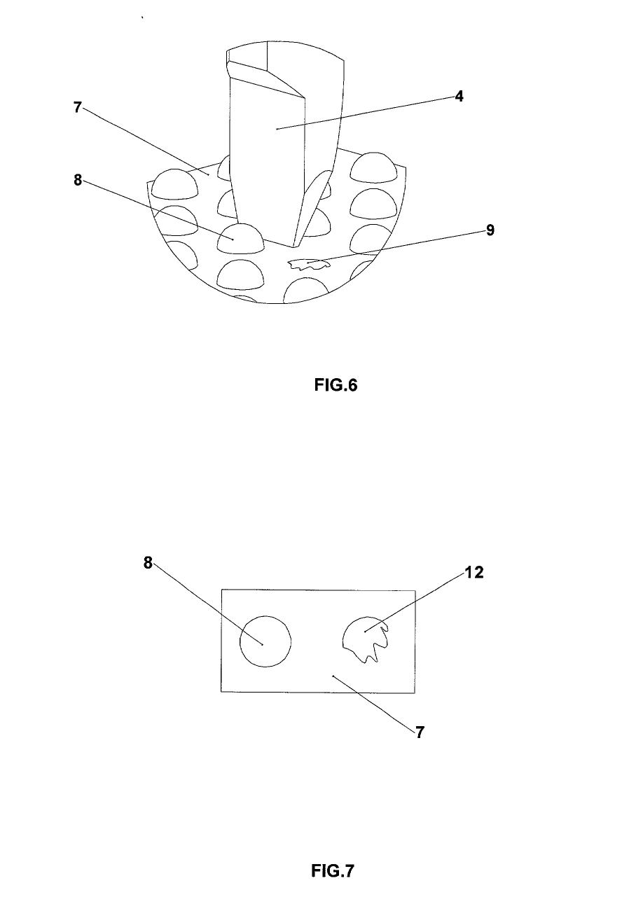

Operation—FIGS. 1-6

The Multi Function Bond Strength Test System 1 is used to conduct a shear test, with the operation as follows:

1) A test piece 7 is held in the jaws 6 of a test piece holder 5

2) The test piece holder 5 is positioned and held in place on the X-Y stage 2 of the Multifunction Bond Test System 1

3) The bond to be tested 8 is positioned by the X-Y stage to be aligned with the test tool 4, in the test position under the test tool 10

4) The test tool 4 is lowered and positioned behind the bond to be tested 8 and the shear test sequence is initiated and completed

5) After the test is completed, the X-Y stage 2 of the test system 1 is commanded to move the test piece 7 into position 11 so that the tested bond 12 is under the optics 14 and camera 13 attached to the Multifunction Bond Test System 1 with the mount 15

6) The camera 13 converts an optical image of the tested bond 12 to a digital data stream sent to the frame grabber circuit in the computer 16

7) The image 18 of the tested bond 12 is displayed on the computer monitor 17

8) Test measurements may be accomplished and displayed on the monitor 17 along with test data 19

9) The image 18 and test data 19 may be saved or cancelled

10) The X-Y stage 2 of the system 1 returns test site 9 into position 10 under test tool 4

The system is ready to start the next test.

Conclusion, Ramifications and Scope:

It can be seen from the above descriptions that the Image Capture apparatus of this invention can provide the user of a Multifunction bond strength test machine that it is to be attached to with capability that greatly broadens the utility and convenience of the bond testing operation.

a) It allows digital images of a bond test sites to be captured along with the corresponding test data. This can be easily and readily accomplished by only moderately skilled operators and stored for later off line review and analysis by suitable technical experts.

b) It allows convenient cooperative analysis.

c) It allows creation of harmonized evaluation standards.

d) Image capture allows a relatively permanent record to be conveniently stored, retrieved and exchanged between users of multiple test machines.

e) Creation of standards for evaluation of bonds allows the users to correlate cause and effect relationships that enable development and optimization of production bonding processes as well as diagnosis and resolution of bond problems.

I claim:

1) On a multifunction bond test system, comprising of a system with the addition of the capability to capture an image of the tested bond, the improvement wherein said system has a controlled and coordinated subsystem to position, optically and electronically view and magnify, measure and record images of a tested bond.

2) The controlled and coordinated subsystem of claim 1 wherein the test piece is automatically and accurately positioned between the test tool of the multifunction bond test system and the image capture optics during the strength test and record sequence.

3) The subsystem of claim 1 wherein zoom optics and Electronic camera are positioned to view, magnify and record the image of a tested bond.

4) The magnified view of the tested bond of claim 3 wherein the image is captured and processed electronically via a camera, electronics and a unique software program.

5) The unique software program of claim 4 wherein the program coordinates with the multifunction bond test system and controls the computer that processes and manages the image for display.

6) The unique software program of claim 4 wherein features of the bond image may be measured and quantified.

7) The unique software program of claim 6 wherein measurements are recorded and displayed.

8) The unique software program of claim 7 wherein accompanying measurement and strength test data are managed and overlaid on the recorded or displayed image.
